(19) United States
(12) Patent Application Publication
(10) Pub. No.: US 2006/0066707 A1
(43) Pub. Date: Mar. 30, 2006

(54) Ink jet recording element

(75) Inventors: Olivier J Poncelet, Chalon sur Saone (FR); Stephanie Desrousseaux, Ouroux sur Saone (FR)

Correspondence Address: BETH READ;PATENT LEGAL STAFF, EASTMAN KODAK COMPANY, 343 STATE STREET, ROCHESTER, NY, 14650-2201, US

(73) Assignee: Eastman Kodak Company, Rochester, NY (US)

(21) Appl. No.: 10/522,006

(22) PCT Filed: Jul. 14, 2003
(86) PCT No.: PCT/EP03/07576

§ 371 Date: Jan. 14, 2005

(30) Foreign Application Priority Data
Jul. 18, 2002 (FR) 02/09083

(51) Int. Cl. B41J 3/407

(52) U.S. Cl. 347/106

(57) ABSTRACT

The present invention relates to an ink jet recording element having very good dye keeping properties in time. Said ink jet recording element comprises a support and at least one ink-receiving layer, said ink-receiving layer comprising at least one hydrosoluble binder and at least one aluminosilicate polymer obtainable by a preparation method consisting in treating an aluminum halide with an alkyl orthosilicate only having hydrolyzable functions with an aqueous alkali in the presence of silanol groups, the aluminum concentration being maintained less than 0.3 mol/l, the Al/Si molar ratio being maintained between 1 and 3.6 and the alkali/Al molar ratio being maintained between 2.3 and 3; and then stirring the resulting mixture at ambient temperature in the presence of silanol groups for long enough to form the aluminosilicate polymer.

### FIELD OF THE INVENTION

The present invention relates to an ink jet recording element.

### DESCRIPTION RELATIVE TO THE PRIOR ART

Digital photography has been growing fast for several years; the general public now having access to efficient and reasonably priced digital cameras. Therefore people are seeking to be able to produce photographic prints from a simple computer and its printer, with the best possible quality.

Many printers, especially those linked to personal office automation, use the inkjet printing technique. There are two major families of inkjet printing techniques: continuous jet and drop-on-demand.

Continuous jet is the simpler system. Pressurized ink (3.10⁵ Pa) is forced to go through one or more nozzles so that the ink is transformed into a flow of droplets. In order to obtain the most regular possible sizes and spaces between drops, regular pressure pulses are sent using for example a piezoelectric crystal in contact with the ink with high frequency (up to 1 MHz) alternating current (AC) power supply. So that a message can be printed using a single nozzle, every drop must be individually controlled and directed. Electrostatic energy is used for this: an electrode is placed around the ink jet at the place where drops form. The jet is charged by induction and every drop henceforth carries a charge whose value depends on the applied voltage. The drops then pass between two deflecting plates charged with the opposite sign and then follow a given direction, the amplitude of the movement being proportional to the charge carried by each of the plates. To prevent other drops from reaching the paper, they are left uncharged: so, instead of going to the support they continue their path without being deflected and go directly into a container. The ink is then filtered and can be reused.

The other category of inkjet printer is drop-on-demand (DOD). This constitutes the base of inkjet printers used in office automation. With this method, the pressure in the ink cartridge is not maintained constant but is applied when a character has to be formed. In one widespread system there is a row of 12 open nozzles, each of them being activated with a piezoelectric crystal. The ink contained in the head is given a pulse: the piezo element contracts with an electric voltage, which causes a decrease of volume, leading to the expulsion of the drop by the nozzle. When the element resumes its initial shape, it pumps in the reservoir the ink necessary for new printings. The row of nozzles is thus used to generate a column matrix, so that no deflection of the drop is necessary. One variation of this system consists in replacing the piezoelectric crystals by small heating elements behind each nozzle. The drops are ejected following the forming of bubbles of solvent vapor. The volume increase enables the expulsion of the drop. Finally, there is a pulsed inkjet system in which the ink is solid at ambient temperature. The print head thus has to be heated so that the ink liquefies and can print. This enables rapid drying on a wider range of products than conventional systems.

There now exist new “inkjet” printers capable of producing photographic images of excellent quality. However, they cannot supply good proofs if inferior quality printing paper is used. The choice of printing paper is fundamental for the quality of obtained image. The printing paper must combine the following properties: high quality printed image, rapid drying after printing, good dye keeping in time, smooth appearance and high gloss.

In general, the printing paper comprises a support coated with one or more layers according to the properties required. It is possible, for example, to apply on a support a primary attachment layer, an absorbent layer, an ink fixing layer and a protective layer or surface layer to provide the glossiness of the recording element. The absorbent layer absorbs the liquid part of the water-based ink composition after creation of the image. Elimination of the liquid reduces the risk of ink migration to the surface. The ink fixing layer prevents any ink loss into the fibers of the paper base to obtain good color saturation while preventing excess ink that would encourage the increase in size of the printing dots and reduce the image quality. The absorbent layer and fixing layer can also constitute a single ink-receiving layer ensuing both functions. The protective layer is designed to ensure protection against fingerprints and the pressure marks of the printer feed rollers. The ink-receiving layer usually comprises a binder, a receiving agent and various additives. The purpose of the receiving agent is to fix the dyes in the printing paper. The best-known inorganic receivers are colloidal silica or boehmite. For example, the European Patent Applications EP-A-976,571 and EP-A-1,162,076 describe materials for inkjet printing in which the ink-receiving layer contains as inorganic receivers Ludox™ CL (colloidal silica) marketed by Grace Corporation or Dispal™ (colloidal boehmite) marketed by Sasol. However, printing paper comprising an ink-receiving layer containing such inorganic receivers can have poor image stability in time, which is demonstrated by a loss of color density.

To meet the new requirements of the market in terms of photographic quality, printing speed and color stability, it is necessary to offer a new ink jet recording element having the properties as defined above, more particularly good dye keeping in time as well as a high gloss.

### SUMMARY OF THE INVENTION

The new ink jet recording element according to the present invention comprises a support and at least one ink-receiving layer, and is characterized in that said ink-receiving layer comprises at least one hydrosoluble binder and at least one aluminosilicate polymer obtainable by a preparation method that comprises the following steps:

a) treating a mixed aluminum and silicon alkoxide only comprising hydrolyzable functions, or a mixed aluminum and silicon precursor resulting from the hydrolysis of a mixture of aluminum compounds and silicon compounds only comprising hydrolyzable functions, with an aqueous alkali, in the presence of silanol groups, the aluminum concentration being maintained at less than 0.3 mol/l, the Al/Si molar ratio being maintained between 1 and 3.6 and the alkali/Al molar ratio being maintained between 2.3 and 3;

b) stirring the mixture resulting from step a) at ambient temperature in the presence of silanol groups long enough to form the aluminosilicate polymer; and

c) eliminating the byproducts formed during steps a) and b) from the reaction medium.

Throughout the present description, the expression “hydrolyzable function” means a substituent eliminated by hydrolysis during the process and in particular at the time of treatment with the aqueous alkali. In the following, the expression “unmodified mixed aluminum and silicon alkoxide” or “unmodified mixed aluminum and silicon precursor” means respectively a mixed aluminum and silicon alkoxide only having hydrolyzable functions, or a mixed aluminum and silicon precursor resulting from the hydrolysis of a mixture of aluminum compounds and silicon compounds only having hydrolyzable functions. More generally, an “unmodified” compound is a compound that only comprises hydrolyzable substituents.

The ink jet recording element according to the present invention has improved dye keeping properties in time as well as a good gloss compared with the ink jet recording elements available on the market.

### BRIEF DESCRIPTION OF THE DRAWINGS

FIGS. 1 to 3 represent the spectra obtained by Raman spectroscopy of the aluminosilicate polymers used for comparative purposes and used in the present invention.

FIGS. 4 to 19 represent the percentage of color density loss for various comparative recording elements and according to the present invention when exposed to ozone.

### DETAILED DESCRIPTION OF THE INVENTION

The ink jet recording element according to the present invention comprises firstly a support. This support is selected according to the desired use. It can be a transparent or opaque thermoplastic film; in particular a film based on polyester, polymethylmetacrylate, cellulose acetate, or polyvinyl chloride, and any other appropriate material. The support used in the invention can also be paper, both sides of which may be covered with a polyethylene layer. When the support comprising the paper pulp is coated on both sides with polyethylene, it is called Resin Coated Paper (RC Paper) and is marketed under various brand names. This type of support is especially preferred to constitute a inkjet recording element. The side of the support that is used can be coated with a very thin layer of gelatin or another composition to ensure the adhesion of the first layer on the support.

The ink jet recording element according to the invention then comprises at least one ink-receiving layer comprising at least one hydrosoluble binder. Said hydrosoluble binder can be gelatin or polyvinyl alcohol. The gelatin is that conventionally used in the photographic field. Such a gelatin is described in Research Disclosure, September 1994, No. 36544, part IIA. Research Disclosure is a publication of Kenneth Mason Publications Ltd., Dudley House, 12 North Street, Emsworth, Hampshire PO10 7DQ, United Kingdom. The gelatin can be obtained from SKW and the polyvinyl alcohol from Nippon Gohsei, or Air Product under the name Airvol® 130.

According to the present invention, the ink-receiving layer comprises, as receiving agent, at least one aluminosilicate polymer obtainable by a preparation method comprising the following steps:

a) treating a mixed aluminum and silicon alkoxide only comprising hydrolyzable functions, or a mixed aluminum and silicon precursor resulting from the hydrolysis of a mixture of aluminum compounds and silicon compounds only comprising hydrolyzable functions, with an aqueous alkali, in the presence of silanol groups, the aluminum concentration being maintained at less than 0.3 mol/l, the Al/Si molar ratio being maintained between 1 and 3.6 and the alkali/Al molar ratio being maintained between 2.3 and 3;

b) stirring the mixture resulting from step a) at ambient temperature in the presence of silanol groups long enough to form the aluminosilicate polymer; and

c) eliminating the byproducts formed during steps a) and b) from the reaction medium.

According to one embodiment, the unmodified mixed aluminum and silicon precursor can be formed in situ by mixing in aqueous medium (i) one compound selected from the group consisting of aluminum salts, aluminum alkoxides and aluminum halogenoalkoxides and (ii) at least one compound selected from the group consisting of unmodified silicon alkoxides and chloroalkoxides. The alkoxide radical of the unmodified aluminum compound or silicon compound preferably contains 1 to 5 carbon atoms, such as methoxide, ethoxide, n-propoxide, or i-propoxide.

Preferably, an aluminum salt, such as a halide (e.g. chloride or bromide), a perhalogenate, a sulfate, a nitrate, a phosphate or a carboxylate, and at least one unmodified silicon alkoxide, such as tetramethyl or tetraethyl orthosilicate is used.

A single unmodified silicon alkoxide or a mixture of unmodified silicon alkoxides, or a single unmodified silicon chloroalkoxide or a mixture of unmodified silicon chloroalkoxides, or a mixture of unmodified silicon alkoxides and chloroalkoxides can be used.

Preferably, an aluminum halide, such as chloride, and an unmodified silicon alkoxide is used. In practice, the mixture is made at ambient temperature between 15° C. and 35° C., preferably between 20° C. and 25° C., by adding the silicon alkoxide, pure or diluted in a co-solvent such as an alcohol, to the aluminum salt in aqueous solution, with stirring, until a clear homogeneous mixture is obtained. An unmodified mixed aluminum and silicon precursor is thus obtained. The stirring time varies from 10 to 180 minutes, and is preferably 120 minutes.

According to step a) of the method for preparing the aluminosilicate polymer useful in the invention, the precursor or an unmodified mixed aluminum and silicon alkoxide is then put in contact with an aqueous alkali, the aluminum concentration being maintained at less than 0.3 mol/l, the Al/Si molar ratio being maintained between 1 and 3.6, and the alkali/Al molar ratio being maintained between 2.3 and 3. Advantageously, the aluminum concentration is between 1.5×10⁻² and 0.3 mol/l and even more preferably between 4.4×10⁻² and 0.3 mol/l. Preferably, the Al/Si molar ratio is between 1 and 2.

Preferably, an aqueous solution of sodium, potassium or lithium hydroxide, diethylamine or triethylamine with a concentration between 0.5 M and 3 M, and preferably 3 M is used. The alkali can also be in the form of an hydroalcoholic solution.

The alkali is added to the precursor or to the unmodified mixed aluminum and silicon alkoxide at a rate preferably between 50 and 650 mmoles/hour.

The alkali in step a) is added in the presence of silanol groups. These groups can be supplied by glass or silica (glass wool) particles or beads, which have superficial hydroxy groups. When the volume of liquid to be treated is large, it maybe desirable to increase the quantity of beads. The diameter of the beads can be between 0.2 and 5 mm and preferably between 1 and 3 mm. To simplify the implementation of the method for preparing the aluminosilicate polymer useful in the present invention, the preparation of the mixed aluminum and silicon precursor can also be performed in the presence of silanol groups, for example by circulating the mixture in a bed of glass beads.

After the addition of the alkali, step b) of the method for preparing the aluminosilicate polymer useful in the present invention consists in stirring the mixture resulting from step a) at ambient temperature in the presence of silanol groups long enough to form the said aluminosilicate polymer.

Then, step c) of the method for preparing the aluminosilicate polymer useful in the present invention consists in eliminating from the reaction medium the byproducts formed during steps a) and b), such as the residual ions coming essentially from the alkali used in step a). The residual ions can be eliminated by washing, by successive sedimentation or by diafiltration. The aluminosilicate polymer material resulting from step c) can then be concentrated by centrifugation or nanofiltration.

In a first embodiment of the method for preparing the aluminosilicate polymer useful in the present invention, during step a) a quantity of alkali is added in order to obtain an alkali/Al molar ratio of about 2.3. In this case the pH is maintained between 4 and 5, and preferably between 4.2 and 4.3. Then step b) as described above is applied. The aluminosilicate polymer useful in the present invention is thus obtained in dispersion form. Step c) to eliminate the residual ions can then be performed by diafiltration, followed by nanofiltration concentration.

In a second embodiment of the method for preparing the aluminosilicate polymer useful in the present invention, during step a) a quantity of alkali is added in order to obtain an alkali/Al molar ratio of about 3. Then step b) as described above is applied. The aluminosilicate polymer useful in the present invention is thus obtained in suspension form. Step c) to eliminate the residual ions can then be performed by diafiltration, followed by nanofiltration concentration, the aluminosilicate polymer having been previously redispersed by adding acid, such as hydrochloric or acetic acid or a mixture thereof.

In a third embodiment, the method for preparing the aluminosilicate polymer useful in the present invention comprises an additional step d), after step b) and before step c). Said step d) consists in adding in a few minutes an additional quantity of aqueous alkali to reach an alkali/Al molar ratio of 3 if this ratio had not already been reached during step a). The aluminosilicate polymer useful in the present invention is thus obtained in suspension form. Step c) to eliminate the residual ions can then be performed by diafiltration, followed by nanofiltration concentration, the aluminosilicate polymer having been previously redispersed by adding hydrochloric acid. Step c) can also be performed by washing with osmosed water by successive sedimentations, followed by centrifugation concentration.

The aluminosilicate polymer useful in the present invention resulting from step c) followed by concentration has physical gel form. The Al/Si molar ratio is between 1 and 3.6. Subsequent lyophilization enables the aluminosilicate polymer useful in the present invention to be obtained as a powder. Such an aluminosilicate polymer can be characterized in that its Raman spectrum comprises in spectral region 200-600 cm^{31 1} a wide band at 250±6 cm⁻¹, a wide intense band at 359±6 cm⁻¹, a shoulder at 407±7 cm⁻¹, and a wide band at 501±6 cm⁻¹, the Raman spectrum being produced for the aluminosilicate polymer resulting from step b) and before step c) and lyophilized.

In another embodiment, the method for preparing the aluminosilicate polymer useful in the present invention comprises an additional step e), after step c), by which at least one chelating agent of aluminum is added to the aluminosilicate polymer resulting from step c). Then the mixture is stirred. Subsequent evacuation by vacuum enables the aluminosilicate polymer useful in the invention to be obtained in solid form.

Said chelating agent of aluminum can be selected from the group consisting of carboxylic acids, phosphonic acids, sulfonic acids, difunctional acids, their ester and anhydride components and amino acids. Preferably, the chelating agent of aluminum is selected from the group consisting of HCOOH, R₁COOH wherein R₁ is selected from the group consisting of CH₃(CH₂)ₙ, n being between to 0 and 12, CF₃, C₆H₅, (C₆H₅)₂, substituted aromatic rings as in salicylic acid, C₄H₄S; R₂PO(OH)₂ wherein R₂ is selected from the group consisting of CH₃, C₆H₅; R₃SO₃H wherein R₃ is CH₃(CH₂)ₙ, n being between to 0 and 5; HOOC(CH₂)ₙCOOH, n=0-8; aromatic difunctional acids as phtalic acid; HOOC(CH₂)ₙPO(OH)₂, n=2, 4; hydroxy aliphatic acids; HOOC(CH₂OH)ₙCOOH, n=1-2; CH₃CH(NH₂)COOH. Preferably, the chelating agent is acetic acid.

The useful solvent of chelating agent of aluminum is generally water but another solvent miscible to water can be used in order to solubilize the chelating agent before its adding to the aluminosilicate polymer resulting from step c).

Step e) can be applied directly on the aluminosilicate polymer resulting from step c) to prepare a aluminosilicate polymer resulting from step e) or when a coating composition for the preparation of the ink-receiving layer is prepared by using a aluminosilicate polymer resulting from step c).

Step e) can comprise a first adding of acetic acid and a following adding of another different chelating agent of aluminum. This method is particularly useful to help the chelation when the chelating agent comprises large bulky groups.

The amount of chelating agent of aluminum in the ink-receiving layer corresponds to a molar ratio between the chelating functions of the chelating agent and aluminum of the aluminosilicate polymer, wherein this molar ratio is less than 1. Preferably, the molar ratio is greater than 0.1 and less than 1. The introduction of a chelating agent of aluminum allows to modify the surface of the aluminosilicate polymer by forming a chelate compound. The functional group of the chelating agent allows to increase the affinity of the aluminosilicate polymer with the medium in which it is used.

The Raman spectrum of the aluminosilicate polymer material resulting from step e) comprises the same bands as the aluminosilicate polymer material resulting from step b), as well as bands corresponding to the chelating agent in its chelate form. The aluminosilicate polymer useful in the present invention resulting from step e) has physical gel form. The Al/Si molar ratio is between 1 and 3.6.

The ink-receiving layer comprises from 5 to 95 percent by weight of aluminosilicate polymer compared with the total weight of the dry state ink-receiving layer.

The present invention also relates to the composition intended to be coated on the support to constitute the ink-receiving layer of the recording element described above. To produce this composition, the hydrosoluble binder is diluted in water to adjust its viscosity and facilitate its coating. The composition then has the form of an aqueous solution or a dispersion containing all the necessary components. When the aluminosilicate polymer as obtained above is used for preparing the composition as a powder, this powder must be very fine.

The composition can also comprise a surfactant to improve its coating properties. The composition can be coated on the support according to any appropriate coating method, such as blade, knife or curtain coating. The composition is applied with a thickness between approximately 100 μm and 200 μm in the wet state. The composition forming the ink-receiving layer can be applied to both sides of the support. It is also possible to provide an antistatic or anti-winding layer on the back of the support coated with the ink-receiving layer.

The ink jet recording element according to the invention can comprise, besides the ink-receiving layer described above, other layers having another function, arranged above or below said ink-receiving layer. The ink-receiving layer as well as the other layers can comprise all the other additives known to those skilled in the art to improve the properties of the resulting image, such as UV ray absorbers, optical brightening agents, antioxidants, plasticizers, etc.

The ink-receiving layer useful in the present invention has a thickness generally between 5 μm and 50 μm in the dry state. The ink jet recording element comprising such an ink-receiving layer has improved dye keeping properties in time as well as gloss. It can be used for any type of inkjet printer as well as for all the inks developed for this technology.

The following examples illustrate the present invention without however limiting the scope.

1) Preparation of Various Aluminosilicates

### EXAMPLE 1

An aluminosilicate polymer in hollow sphere form was prepared according to the method described in Patent U.S. Pat. No. 6,254,845.

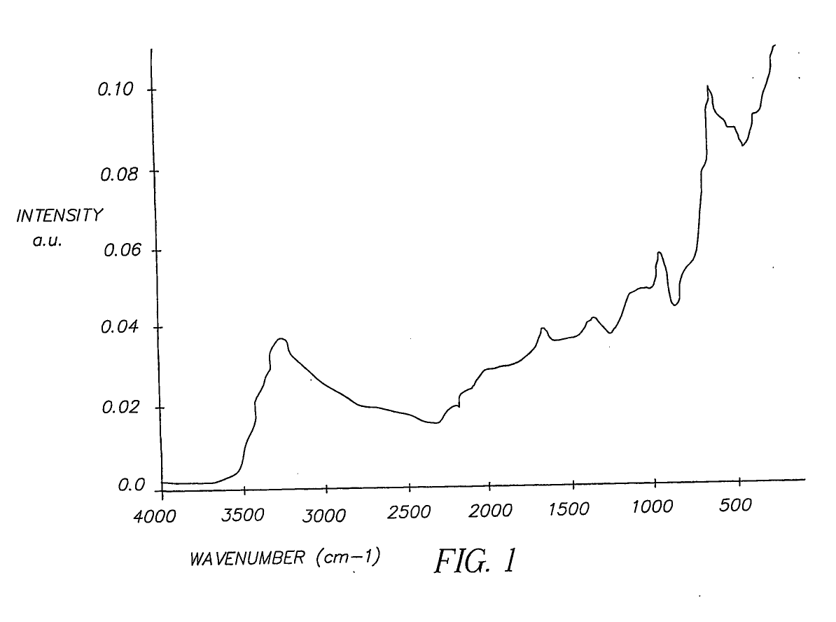

Sodium orthosilicate was dissolved in purified water to obtain 50 ml of an aqueous solution at 0.1 mol/l. Separately, aluminum chloride was dissolved in purified water to obtain 67.15 ml of an aqueous solution at 0.1 mol/l. The aluminum chloride solution was mixed at high speed with the aqueous solution of sodium orthosilicate. At this stage, the aluminum concentration was 5.7×10⁻² mol/l. The Al/Si molar ratio was 1.34. The mixture was stirred for one hour at ambient temperature. A suspension was obtained that was filtered using a membrane filter to eliminate byproducts such as sodium chloride. The retentate that adhered to the filter was recovered, and 120 ml of purified water was added to it. The mixture was dispersed using ultrasound for one hour and then warmed for five days at 80° C., washed with purified water, and dried in normal conditions of temperature and pressure, and then lyophilized. An aluminosilicate polymer was obtained in hollow spherical particle form. This polymer was identified by its Raman signature or spectrum represented by FIG. 1.

In all the examples described, a Raman Bruker RFS 100 spectrometer (laser exciting wavelength, 1064 nm, power 800 mW and 512 scans) was used to obtain the Raman spectra The spectra were acquired in reflection mode (180°) using a lens with semi-cylindrical mirror. Samples were analyzed in solid form (obtained by lyophilization) without special preparation. The Raman spectrum instead of infrared spectrum was preferred, because the materials used in the present invention were water rich and the infrared spectrum of the material was then masked by the water. This problem did not appear with the Raman spectra technology. Materials that have the same Raman signature belong to the same family.

### EXAMPLE 2

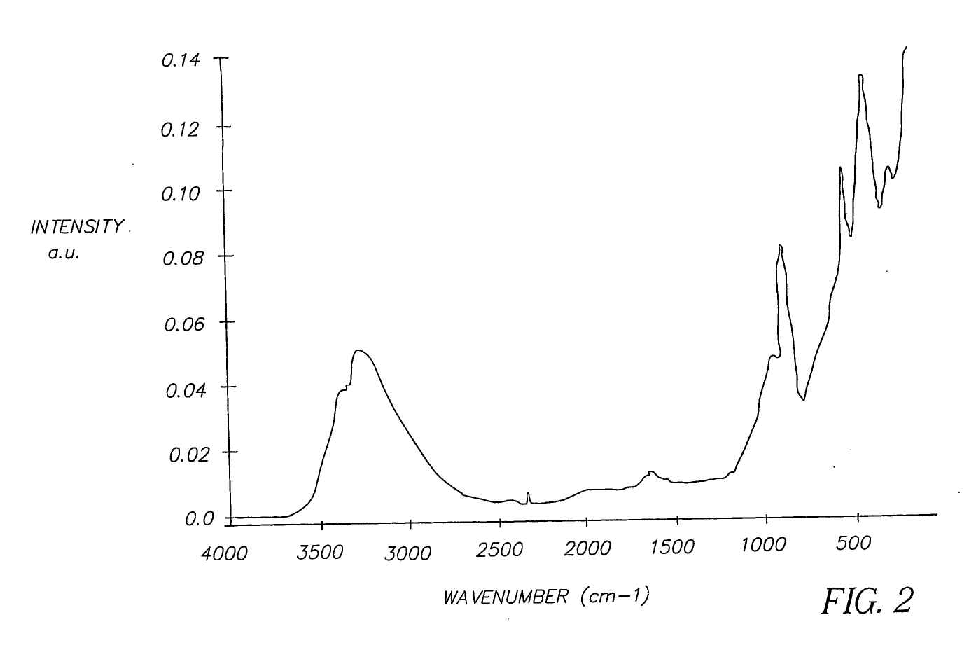

4.53 moles AlCl₃, 6H₂O, then 2.52 moles tetraethyl orthosilicate were added to 100 l osmosed water. This mixture was stirred and circulated simultaneously through a bed formed of 1-kg glass beads 2-mm diameter using a pump with 8-1/min output. The operation to prepare the unmodified mixed aluminum and silicon precursor took 60 minutes. Then, according to step a) of the method for preparing the aluminosilicate polymer used in the present invention, 10.5 moles NaOH 3M were added to the precursor in two hours. The reaction medium clouded. According to step b) of the preparation method, the mixture was stirred for 18 hours. The medium became clear. The circulation was stopped in the glass bead bed. Then, according to step d) of the preparation method, 3.09 moles NaOH 3M were added in ten minutes. Aluminum concentration was 4.4×10⁻² mol/l, Al/Si molar ratio 1.8 and alkali/Al ratio 3. The aluminosilicate polymer useful in the present invention was thus obtained as a suspension. FIG. 2 represents the Raman spectrum of this polymer that was lyophilized to obtain its Raman signature. Step c) of the preparation method consisted in leaving the polymer suspension to settle for 24 hours, then in discarding the supernatant to recover the sediment. This sediment was washed with osmosed water by successive sedimentations to obtain a sodium level in the supernatant less than 10 ppm. Then the sediment was centrifuged to obtain a gel with about 4% by weight of aluminosilicate polymer according to the invention. The resulting gel was lyophilized (20 mT, −50° C.) to obtain a solid of constant mass. The aluminosilicate polymer useful in the present invention was then obtained as a powder. For its use in the composition that is going to constitute the ink-receiving layer, the powder can be redispersed by adding water and acid, such as hydrochloric or acetic acid, and with mechanical stirring.

### EXAMPLE 3

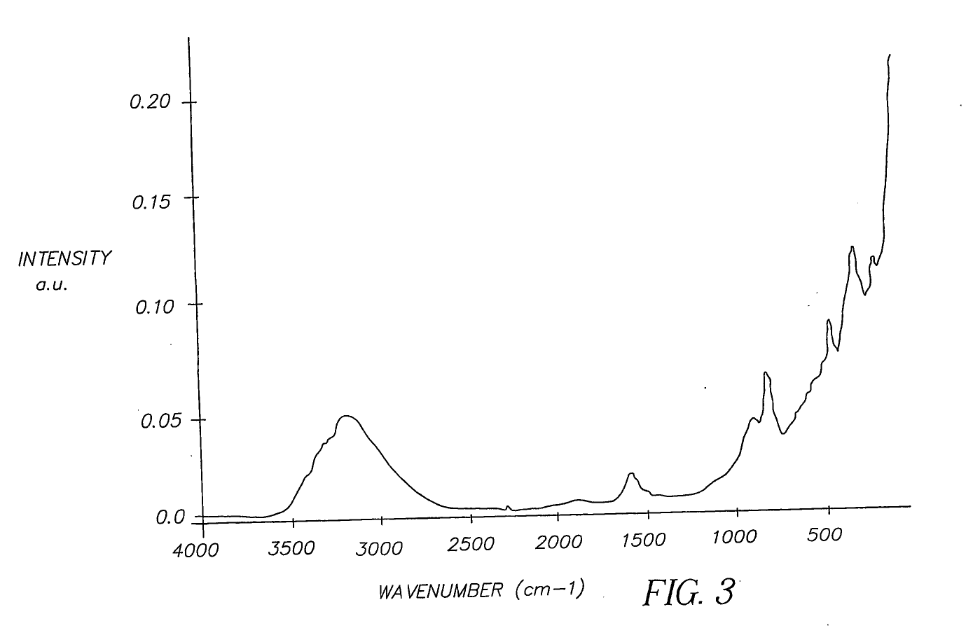

100 l of osmosed water were poured into a plastic (polypropylene) reactor. 4.53 moles AlCl₃, 6H₂O, then 2.52 moles tetraethyl orthosilicate were added. This mixture was stirred and circulated simultaneously through a bed formed of 1-kg glass beads 2-mm diameter using a pump with 8-1/min output. The operation to prepare the unmodified mixed aluminum and silicon precursor took 90 minutes. Then, according to step a) of the preparation method, 10.5 moles NaOH 3M were added to the contents of the reactor in two hours. Aluminum concentration was 4.4×10^{—2} mol/l, Al/Si molar ratio 1.8 and alkali/Al ratio 2.31. The reaction medium clouded. According to step b) of the preparation method, the mixture was stirred for 48 hours. The medium became clear. The circulation was stopped in the glass bead bed. The aluminosilicate polymer used in the present invention was thus obtained as a dispersion. FIG. 3 represents the Raman spectrum of this polymer that was lyophilized to obtain its Raman signature. Step c) of the preparation method consisted in performing preconcentration by a factor of 3 by nanofiltration, then diafiltration using a Filmtec NF 2540 nanofiltration membrane (surface area 6 m²) to eliminate the sodium salts to obtain an Al/Na rate greater than 100. The retentate resulting from the diafiltration by nanofiltration was concentrated to obtain a gel with about 20 percent by weight of aluminosilicate polymer used in the present invention.

### EXAMPLE 4

20 moles AlCl₃, 6H₂O, then 4.5 kg glass beads 2-mm diameter, then 11.1 moles tetraethyl orthosilicate were added to 100 1 osmosed water. This mixture was stirred vigorously. The operation to prepare the unmodified mixed aluminum and silicon precursor took 30 minutes to obtain a clear homogeneous medium. Then, according to step a) of the preparation method, 60 moles NaOH dissolved in 100 liters of osmosed water were added to the reaction medium, in 30 minutes. The reaction medium clouded. Aluminum concentration was 0.1 mol/l, Al/Si molar ratio 1.8 and alkali/Al ratio 3. According to step b) of the preparation method, the mixture was stirred for 15 minutes. The aluminosilicate polymer used in the present invention was thus obtained as a suspension. Step c) of the preparation method consisted in adding 930 g HCl 37 percent first diluted 10 times and stirring for 150 minutes to obtain a dispersion of the aluminosilicate polymer. The dispersion was then diafiltrated using a Filmtec NF 2540 nanofiltration membrane (surface area 6 m²) to eliminate the sodium salts to achieve an Al/Na ratio greater than 100. The retentate resulting from the diafiltration by nanofiltration was concentrated to obtain a gel with about 20 percent by weight of aluminosilicate polymer used in the present invention.

2) Preparation of Coating Compositions Constituting an Ink-Receiving Layer Coated on a Support

As hydrosoluble binder of polyvinylic alcohol (Gohsenol™ GH23 marketed by Nippon Gohsei) diluted 9 percent in osmosed water and as receiving agent the aluminosilicate polymers prepared according to examples 1 to 4 were used, as well as an aqueous dispersion of pyrogenated alumina (CAB-O-SPERSE® PG003 marketed by Cabot), an aqueous solution of colloidal silica (Ludox™ TMA marketed by Grace Corporation) and boehmite (Disperal™ HP 14/2 marketed by Sasol).

All the compositions resulted from mixing:

15.22 g water

3 g receiving agent (dry matter)

4 g polyvinylic alcohol.

When the receiving agent has powder form, the particles must first be crushed finely.

3) Preparation of Ink Jet Recording Elements

To do this, a Resin Coated Paper type support was placed on a coating machine, first coated with a very thin gelatin layer, and held on the coating machine by vacuum. This support was coated with a composition as prepared according to paragraph 2 using a spiral filmograph 125 μm thick. Then, it was left to dry overnight at ambient air temperature (21° C.).

The resulting recording elements correspond to the examples shown in Table I below giving the receiving agent used in the ink-receiving layer:

TABLE I

| Recording element | Receiving agent in the ink-receiving layer |
|---|---|
| Ex 5 (comp.) | Aluminosilicate prepared according to Example 1 |
| Ex 6 (inv.) | Aluminosilicate prepared according to Example 2 |
| Ex 7 (inv.) | Aluminosilicate prepared according to Example 3 |
| Ex 8 (inv.) | Aluminosilicate prepared according to Example 4 |
| Ex 9 (comp.) | CAB-O-SPERSE ® PG003 |
| Ex 10 (comp.) | Ludox ™ TMA |
| Ex 11 (comp.) | Boehmite (Disperal ™ HP 14/2) |

4) Evaluation of Dye Keeping Properties in Time

To evaluate the dye keeping properties in time, a dye fading test by exposure to ozone was performed for each resulting recording element. To do this, targets comprising four colors (black, yellow, cyan and magenta) were printed on each recording element using a Lexmark KODAK PPM 200 printer and related ink. The targets were analyzed using a Vannier-Photelec densitometer that measures the density of the various colors. Then the recording elements were placed to the dark in a room with controlled ozone atmosphere (60 ppb) for three weeks. Each week, any degradation of the color density was monitored using the densitometer. If density losses were less than 10 percent, for all the colors, it was considered that the recording element enables particularly stable printing to be obtained.

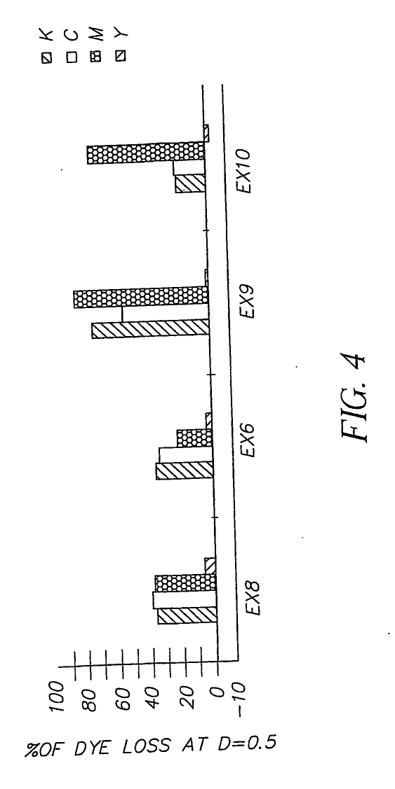

FIG. 4 represents the percentage of density loss observed for the original density 0.5 for the four colors of the targets after one week for examples 6 and 8, 9, 10. Letters K, C, M and Y represent the colors black, cyan, magenta and yellow respectively.

It may be seen that ink jet recording elements according to the invention have good dye keeping properties in time compared with recording elements containing other inorganic receiving agents available on the market. In particular, the color magenta is much more degraded for the comparative examples than for recording elements according to the invention.

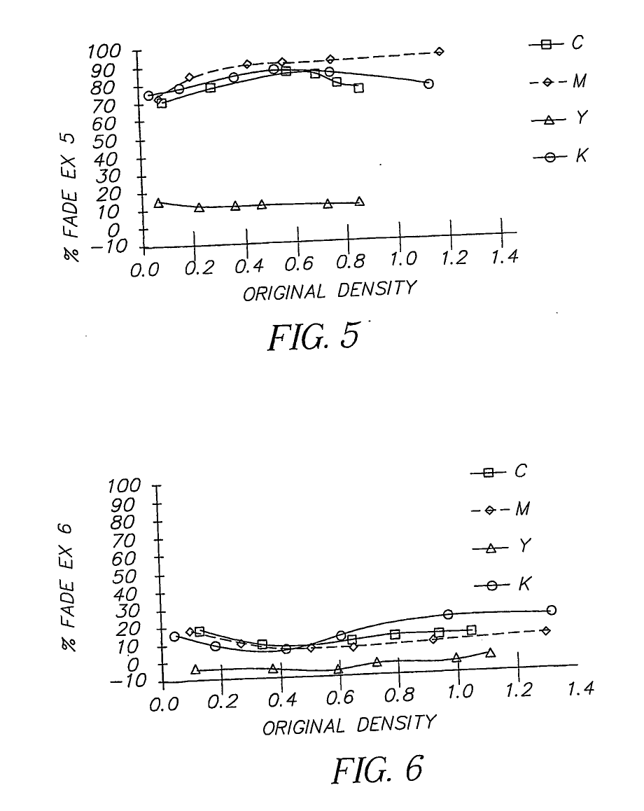

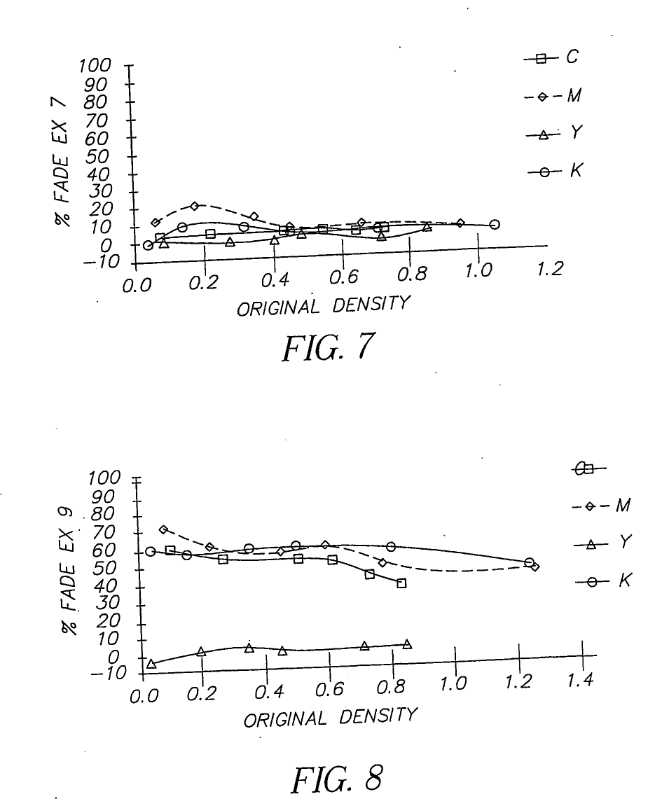

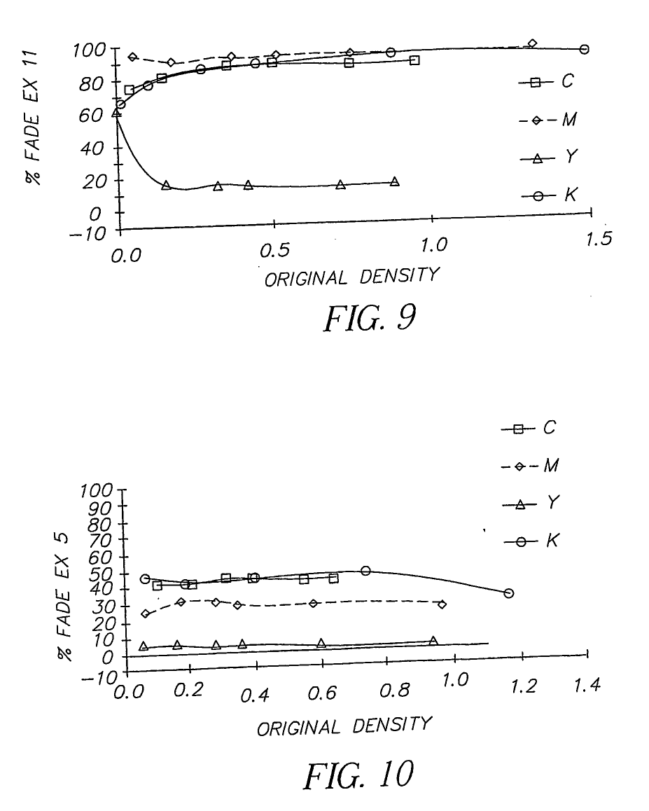

FIGS. 5 to 9 represent the percentage of density loss observed according to the original densities for the four colors of the targets after three weeks for examples 5, 6, 7, 9 and 11 respectively. Once again, the figures clearly demonstrate that the recording elements according to the invention (Ex 6 and 7 corresponding to FIGS. 6 and 7) have very good dye keeping properties compared with the recording elements containing inorganic receiving agents available on the market (Ex 5, 9 and 11) and are approximately stable for all the colors. On the other hand, up to 90-95 percent of density loss for the color magenta and up to 85-90 percent of density loss for the color cyan for the comparative Examples 5 and 11 corresponding to FIGS. 5 and 9 can be seen.

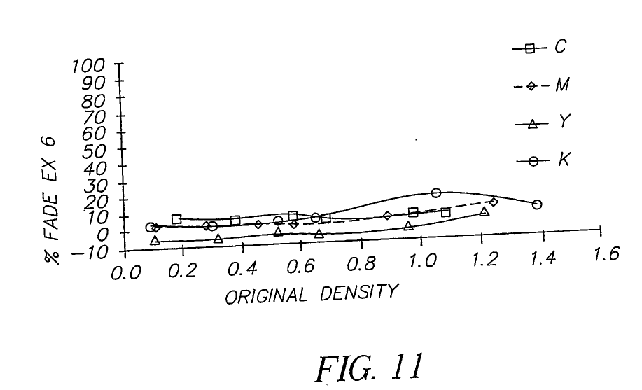

The tests were repeated using an Epson 670 printer and the related Epson ink for the recording elements of examples 5 and 6. FIGS. 10 and 11 represent the percentage of density loss observed according to the original densities for the four colors of the target after three week for said examples 5 and 6 respectively. The colors of the recording element according to the invention (FIG. 11) are approximately stable while the colors cyan and magenta of the recording element of the comparative Example 5 lose between 30 and 40 percent density.

5) Evaluation of the Gloss

Gloss was measured for various resulting recording elements using a Picogloss 560 apparatus (60° geometry) marketed by Erichsen.

The results are given below in Table II.

TABLE II

| | Gloss |
|---|---|
| Recording element | (percent) |
| Ex 5 (comp.) | 2 |
| Ex 7 (inv.) | 55 |
| Ex 11 (comp.) | 45 |

The results of Table II show that the recording elements according to the present invention show a good gloss, which is wanted to reproduce the gloss of photographs developed by a conventional silver process.
6) Examples 12-16 of Aluminosilicate Polymers

### EXAMPLE 12

The procedure of example 2 was repeated, except that step c) of the method for preparing the aluminosilicate polymer used in the invention consisted in leaving the resulting polymer suspension to settle for 24 hours, then in discarding the supernatant to recover the sediment. Then 166 g HCl 37%, previously diluted 10 times, were added to the sediment to obtain a dispersion of the aluminosilicate polymer. The dispersion was then diafiltrated using a Filmtec NF 2540 nanofiltration membrane (surface area 6 m²) to eliminate the sodium salts to achieve an Al/Na ratio greater than 100. Then the retentate resulting from the diafiltration by nanofiltration was concentrated to obtain a gel with about 20% by weight of aluminosilicate polymer useful in the invention.

### EXAMPLE 13

100 g of gel of aluminosilicate polymer obtained in Example 12 (Al amount=1.54 g, 57 mmol, measured by inductively coupled plasma atomic emission spectroscopy, ICP) was diluted with 100 g of osmosed water. Glacial acetic acid (1.7 g, 28.3 mmol) was added to the gel. The mixture was stirred during 2 days. The excess of water and the unreacted acetic acid were removed by evacuation under vacuum at 35° C. A white powder was obtained. The Raman spectrum of this aluminosilicate polymer material comprises the bands of the aluminosilicate polymer obtained in Example 2, as well as the bands corresponding to the chelating agent in its acetate form.

### EXAMPLE 14

100 g of gel of aluminosilicate polymer obtained in Example 12 (Al amount=1.54 g, 57 mmol) was diluted with 100 g of osmosed water. Propionic acid (2.0 g, 27.7 mmol) was added to the gel. The mixture was stirred during 2 days. The excess of water and the unreacted acetic acid were removed by evacuation under vacuum at 35° C. A white powder was obtained. The Raman spectrum of this aluminosilicate polymer material comprises the bands of the aluminosilicate polymer obtained in Example 2, as well as the bands corresponding to the chelating agent in its propionate form.

### EXAMPLE 15

Methyl phosphonic acid powder (1.7 g, 10.4 mmol) was solubilized in ethanol (10 ml). 40 g of gel of aluminosilicate polymer (Al amount=0.950 g, 35 mmol) obtained in Example 12 diluted with 20 g of osmosed water were added to the alcoholic solution of methyl phosphonic acid. The mixture was stirred during 4 days. The excess of ethanol was removed by evacuation under vacuum at 35° C. A white powder was obtained.

### EXAMPLE 16

20 g of gel of aluminosilicate polymer (Al amount=0.8 g, 29 mmol) obtained in Example 12 was diluted with 20 g of osmosed water. Methyl sulfonic acid (1.6 g, 16.6 mmol) was added to the gel. The mixture was stirred during 4 days. The excess of water was removed by evacuation under vacuum at 35° C. A white powder was obtained.

7) Preparation of Coating Compositions Constituting an Ink-Receiving Layer Coated on a Support

As hydrosoluble binder of polyvinylic alcohol (Gohsenol™ GH23 marketed by Nippon Gohsei) diluted 9 percent in osmosed water and as receiving agent the aluminosilicate polymers prepared according to examples 13 to 16 were used.

All the compositions resulted from mixing:

10.1 g water

2 g receiving agent (dry matter)

2.7 g polyvinylic alcohol.

When the receiving agent has powder form, the particles must first be crushed finely. The mixtures were sheared overnight.

8) Preparation of Ink Jet Recording Elements

A Resin Coated Paper type support was placed on a coating machine, first coated with a very thin gelatin layer, and held on the coating machine by vacuum. This support was coated with a composition as prepared according to paragraph 7 using a blade. The wet thickness was 125 μm. Then, it was left to dry 3 hours at ambient air temperature (21° C.).

The resulting recording elements correspond to the examples shown in Table III below giving the receiving agent used in the ink-receiving layer:

TABLE III

| Recording element | Receiving agent in the ink-receiving layer |
|---|---|
| Ex 17 (inv.) | Aluminosilicate prepared according to Example 13 |
| Ex 18 (inv.) | Aluninosilicate prepared according to Example 14 |
| Ex 19 (inv.) | Aluminosilicate prepared according to Example 15 |
| Ex 20 (inv.) | Aluminosilicate prepared according to Example 16 |

9) Evaluation of Dye Keeping Properties in Time

The evaluation of dye keeping properties was made as in paragraph 4.

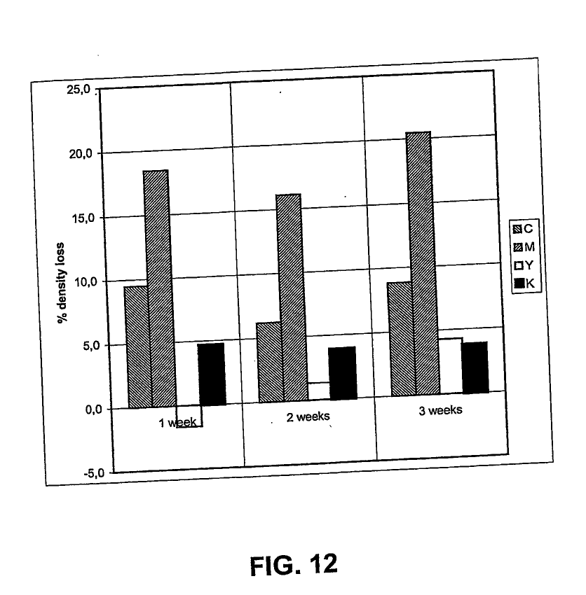

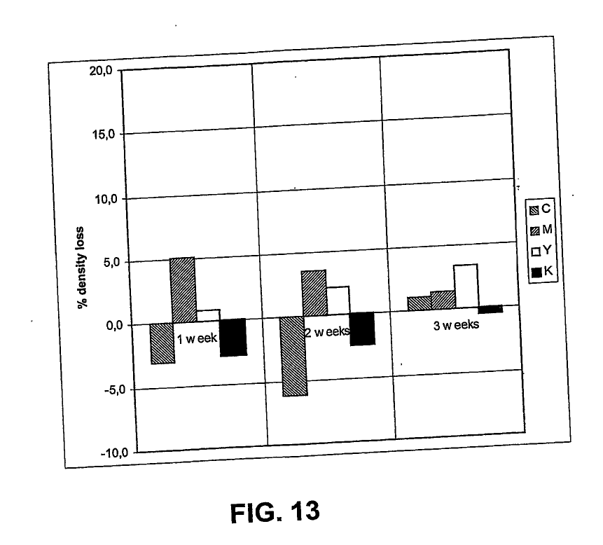

FIGS. 12 and 13 represent the percentage of density loss observed for the original density 0.5 for the four colors of the target for each week for Example 17 printed using the Lexmark Kodak PPM200 printer and related ink and an Epson 670 printer and related Epson ink respectively. Letter C, M, Y and K represent the colors cyan, magenta, yellow and black respectively.

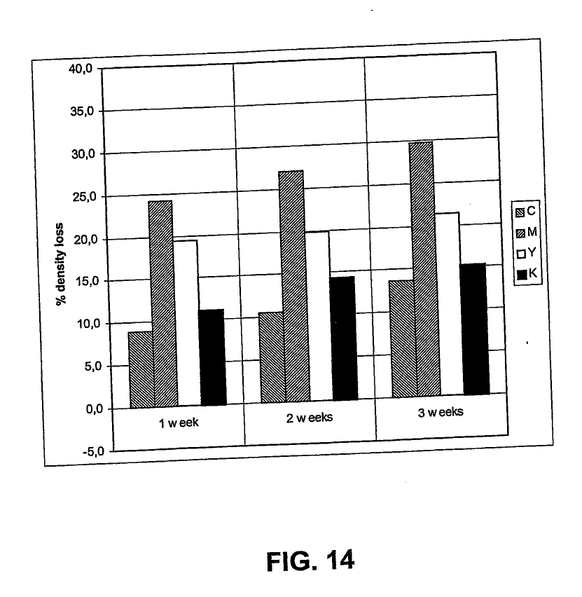

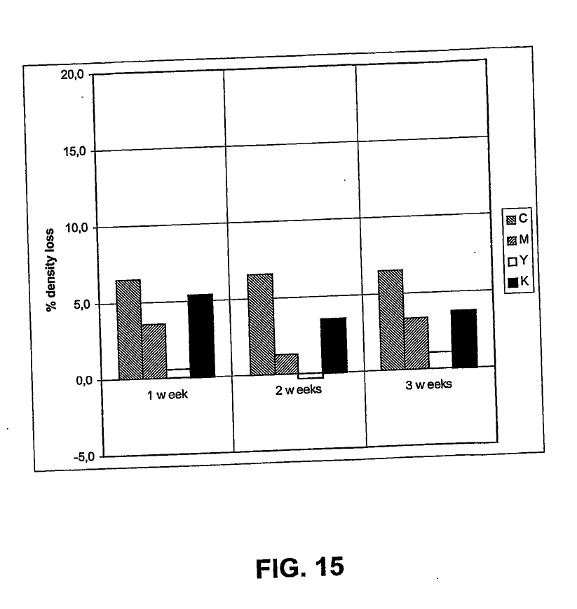

FIGS. 14 and 15 represent the percentage of density loss observed for the original density 0.5 for the four colors of the target for each week for Example 18 printed using the Lexmark Kodak PPM200 printer and related ink and an Epson 670 printer and related Epson ink respectively.

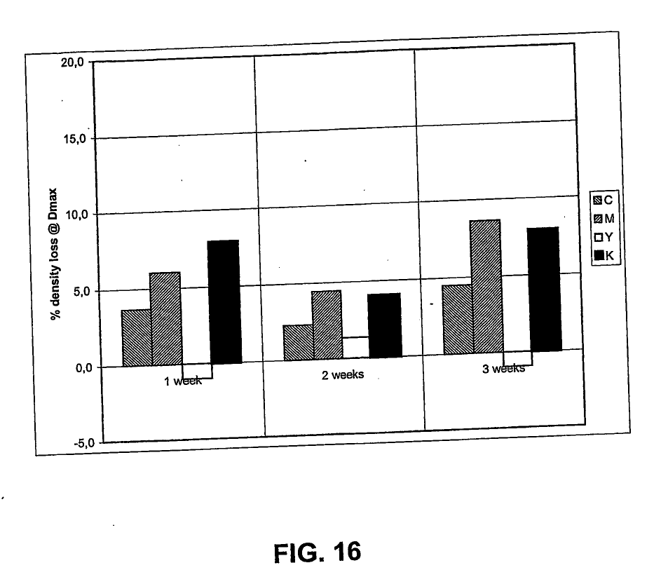

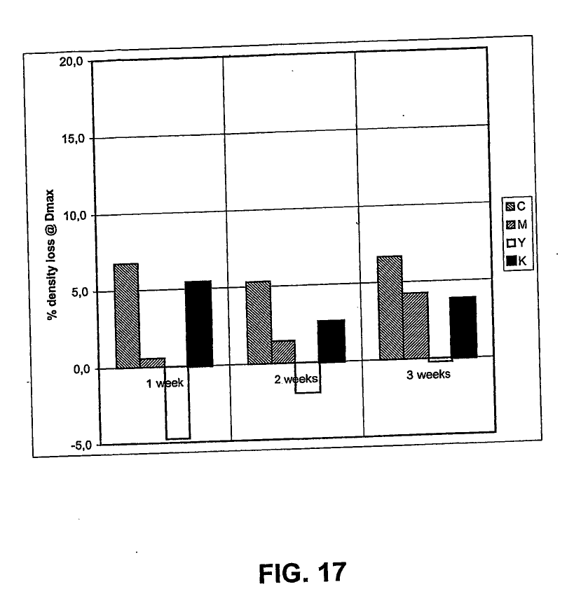

FIGS. 16 and 17 represent the percentage of density loss observed for the maximum density for the four colors of the target for each week for Example 19 printed using the Lexmark Kodak PPM200 printer and related ink and an Epson 670 printer and related Epson ink respectively.

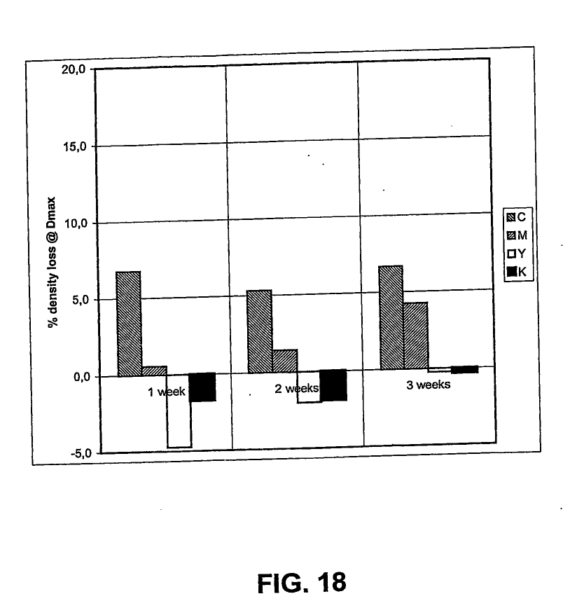

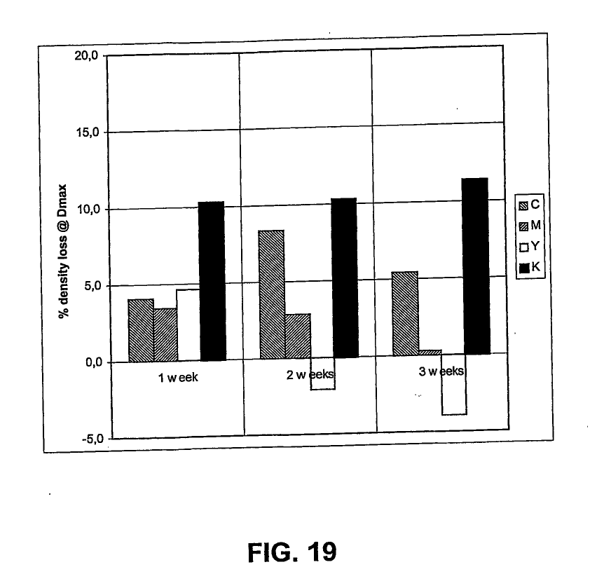

FIGS. 18 and 19 represent the percentage of density loss observed for the maximum density for the four colors of the target for each week for Example 20 printed using the Lexmark Kodak PPM200 printer and related ink and an Epson 890 printer and related Epson ink respectively.

The figures clearly demonstrate that the recording elements according to the invention have very good dye keeping properties.

10) Evaluation of the Gloss

Gloss was measured for resulting recording elements of Examples 17-19 using a Picogloss 560 apparatus (60° geometry) marketed by Erichsen.

The results are given below in Table IV.

TABLE IV

| | Gloss |
|---|---|
| Recording element | (percent) |
| Ex 17 (inv.) | 30 |
| Ex 18 (inv.) | 50 |
| Ex 19 (inv.) | 30 |

The results of Table IV show that the recording elements according to the present invention show a good gloss, which is wanted to reproduce the gloss of photographs developed by a conventional silver process.

1. An ink jet recording element comprising a support and at least one ink-receiving layer, wherein said ink-receiving layer comprises at least one hydrosoluble binder and at least one aluminosilicate polymer obtainable by a preparation method that comprises the following steps:
a) treating a mixed aluminum and silicon alkoxide only comprising hydrolyzable functions, or a mixed aluminum and silicon precursor resulting from the hydrolysis of a mixture of aluminum compounds and silicon compounds only comprising hydrolyzable functions, with an aqueous alkali, in the presence of silanol groups, the aluminum concentration being maintained at less than 0.3 mol/l, the Al/Si molar ratio being maintained between 1 and 3.6 and the alkali/Al molar ratio being maintained between 2.3 and 3;
b) stirring the mixture resulting from step a) at ambient temperature in the presence of silanol groups long enough to form the aluminosilicate polymer; and
c) eliminating the byproducts formed during steps a) and b) from the reaction medium.

2. The recording element according to claim 1, wherein the alkali of step a) to prepare the aluminosilicate polymer is selected from the group consisting of sodium, potassium, and lithium hydroxide, diethylamine, and triethylamine.

3. The recording element according to claim 1, wherein the silanol groups used to prepare the aluminosilicate polymer are supplied in silica or glass bead form.

4. The recording element according to claim 1, wherein the aluminum concentration used to prepare the aluminosilicate polymer is maintained between 1.5×10⁻² and 0.3 mol/l.

5. The recording element according to claim 1, wherein the aluminum concentration used to prepare the aluminosilicate polymer is maintained between 4.4×10⁻² and 0.3 mol/l.

6. The recording element according to claim 1, wherein said alkali/Al molar ratio to prepare the aluminosilicate polymer is about 2.3.

7. The recording element according to claim 1, wherein said alkali/Al molar ratio to prepare the aluminosilicate polymer is about 3.

8. The recording element according to claim 1, wherein the method for preparing the aluminosilicate polymer comprises, after step b) and before step c), a step d), by which alkali is added in order to reach an alkali/Al molar ratio of 3 if this ratio has not already been reached in step a).

9. The recording element according to claim 1, wherein the mixed aluminum and silicon precursor resulting from hydrolysis of a mixture of aluminum compounds and silicon compounds only having hydrolyzable functions is a product resulting from the mixture in an aqueous medium (i) of a compound selected from the group consisting of aluminum salts, aluminum alkoxides and aluminum halogenoalkoxides and (ii) at least one compound selected from the group consisting of silicon alkoxides and chloroalkoxides only having hydrolyzable functions.

10. The recording element according to claim 9, wherein said mixed aluminum and silicon precursor is the product resulting from the mixture (i) of an aluminum halide and (ii) a silicon alkoxide only having hydrolyzable functions.

11. The recording element according to claim 10, wherein said silicon alkoxide only having hydrolyzable functions is tetramethyl orthosilicate or tetraethyl orthosilicate.

12. The recording element according to claim 1, wherein the method for preparing the aluminosilicate polymer comprises, after step c), a step e), by which at least one chelating agent of aluminum is added to the aluminosilicate polymer resulting from step c), wherein the amount of the chelating agent in the ink-receiving layer corresponds to a molar ratio between the chelating functions of the chelating agent and aluminum of the aluminosilicate polymer, and wherein this molar ratio is less than 1.

13. The recording element according to claim 12, wherein step e) is applied directly on the aluminosilicate polymer resulting from step c) to prepare a aluminosilicate polymer resulting from step e) or when a coating composition for the preparation of the ink-receiving layer is prepared by using a aluminosilicate polymer resulting from step c).

14. The recording element according to claim 12, wherein said chelating agent of aluminum is selected from the group consisting of carboxylic acids, phosphonic acids, sulfonic acids, difunctional acids, their ester and anhydride components and amino acids.

15. The recording element according to claim 14, wherein said chelating agent of aluminum is selected from the group consisting of HCOOH, R₁COOH wherein R, is selected from the group consisting of CH₃(CH₂)ₙ, n being between to 0 and 12, CF₃, C₆H₅, (C₆H₅)₂, substituted aromatic rings, C₄H₄S; R₂PO(OH)₂ wherein R₂ is selected from the group consisting of CH₃, C₆H₅; R₃SO₃H wherein R₃ is CH₃(CH₂)ₙ, n being between to 0 and 5;
HOOC(CH₂)ₙCOOH, n=0-8; aromatic difunctional acids;
HOOC(CH₂)ₙPO(OH)₂, n=2, 4; hydroxy aliphatic acids;
HOOC(CH₂OH)ₙCOOH, n=1-2; CH₃CH(NH₂)COOH.

16. The recording element according to claim 12, wherein step e) comprises a first adding of acetic acid and a following adding of another different chelating agent of aluminum.

17. The recording element according to claim 1, wherein said ink-receiving layer comprises between 5 and 95 percent by weight of aluminosilicate polymer compared with the total weight of the dry ink-receiving layer.

18. The recording element according to claim 1, wherein the hydrophilic binder is gelatin or polyvinyl alcohol.

19. A coating composition for the preparation of ink-receiving layers for the ink jet recording element according to claim 1.
